(19) United States
(12) Patent Application Publication
(10) Pub. No.: US 2009/0017770 A1
(43) Pub. Date: Jan. 15, 2009

(54) Noise cancellation system for transceivers

(75) Inventors: Ahmad Mirzaei, Los Angeles, CA (US); Hooman Darabi, Irvine, CA (US); Ahmadreza Rofougaran, Newport Coast, CA (US); Aminghasem Safarian, Tustin, CA (US)

Correspondence Address: FARJAMI & FARJAMI LLP, 26522 LA ALAMEDA AVENUE, SUITE 360, MISSION VIEJO, CA, 92691, US

(73) Assignee: BROADCOM CORPORATION, IRVINE, CA (US)

(21) Appl. No.: 11/827,310

(22) Filed: Jul. 11, 2007

(51) Int. Cl. H04B 1/38

(52) U.S. Cl. 455/73

(57) ABSTRACT

According to one exemplary embodiment, a transceiver providing noise cancellation has a transmitter and a receiver, and comprises a noise cancellation system receiving input from the transmitter. The noise cancellation system generates a noise cancellation signal injected into the receiver such that the noise cancellation signal has an amplitude substantially matching an amplitude of a noise signal in the receiver, and a phase substantially opposite to a phase of the noise signal in the receiver. In one exemplary embodiment, a noise cancellation system comprises a forward injection circuit including a scaling and rotation block, and first and second phase shift and attenuation controllers providing feedback from outputs of the receiver. In one exemplary embodiment, the scaling and rotation block includes first, second, third, and fourth amplifiers to receive a down-converted noise signal and provide a noise cancellation signal.

### BACKGROUND OF THE INVENTION

1. Field of the Invention

The present invention is generally in the field of electronic circuits and systems. More specifically, the present invention is in the field of communications circuits and systems.

2. Background Art

Transceivers are typically used in communications systems to support transmission and reception of communications signals through a common antenna, at radio frequency (RF) in a cellular telephone or other mobile device, for example. Often, in those devices, for example, WCDMA devices, transmission and reception occur concurrently, at frequencies separated by as little as, for instance, 80 MHz. During operation of a transceiver's transmitter, transmission noise may be generated across a range of frequencies, including that frequency range used by the transceiver's receiver for reception signals. In addition, during remote operation, as a mobile device is moved farther from a base station, the strength of its transmission signal must typically increase to compensate for distance, while the strength of a signal being received correspondingly declines. Under those conditions, the transmission noise generated by a transceiver's transmitter, if not suppressed, may significantly interfere with reception quality.

A conventional approach to providing noise suppression in a transceiver utilizes a duplexer to isolate the transmitter from the receiver, in an attempt to screen out interference between the two during concurrent operation. That approach is inadequate, however, due to the finite isolation provided by a transceiver's duplexer. Typically, while providing as much as, for example, 45 dB of attenuation, duplexers commonly in use do not completely isolate a transceiver's receiver from the transmitter. As a result, some transmission noise may leak through the duplexer into the receiver, and this is particularly likely to occur as a transceiver's location grows more remote. Another conventional approach to noise suppression requires high power consumption by the transmitter, in order to optimize the transmitter's signal to noise ratio and thus minimize the transmitter's noise. This conventional approach to suppressing transmission noise has disadvantages of requiring that the mobile transceiver be equipped with a high power transmitter, and requires large power consumption.

Thus, some conventional approaches to suppressing transmission noise may require use of a high power transmitter, result in deterioration of a desired reception signal due to noise leakage through a duplexer, or both. Consequently, there is a need in the art for a noise cancellation system capable of reducing or eliminating an undesirable noise signal, while enabling use of transceivers equipped with low power transmitters.

### SUMMARY OF THE INVENTION

A noise cancellation system for transceivers, substantially as shown in and/or described in connection with at least one of the figures, and as set forth more completely in the claims.

### BRIEF DESCRIPTION OF THE DRAWINGS

FIG. 1 is a block diagram of a conventional approach to noise suppression in, for example, a WCDMA transceiver.

FIG. 2 is a block diagram of a transceiver providing noise cancellation, according to one embodiment of the present invention.

FIG. 3 shows an exemplary noise cancellation system, according to one embodiment of the present invention.

FIG. 4 illustrates a scaling and rotation block utilized in an exemplary noise cancellation system, according to one embodiment of the present invention.

FIG. 5A shows a scaling and rotation matrix corresponding to the operation of the scaling and rotation block of FIG. 4.

FIG. 5B shows an equation corresponding to the transformation of signal components A and B into, respectively, scaled and rotated signal components C and D in FIG. 4.

### DETAILED DESCRIPTION OF THE INVENTION

The present invention is directed to a noise cancellation system in, for example, WCDMA transceivers. Although the invention is described with respect to specific embodiments, the principles of the invention, as defined by the claims appended herein, can obviously be applied beyond the specifically described embodiments of the invention described herein. Moreover, in the description of the present invention, certain details have been left out in order to not obscure the inventive aspects of the invention. The details left out are within the knowledge of a person of ordinary skill in the art.

The drawings in the present application and their accompanying detailed description are directed to merely exemplary embodiments of the invention. To maintain brevity, other embodiments of the invention, which use the principles of the present invention are not specifically described in the present application and are not specifically illustrated by the present drawings.

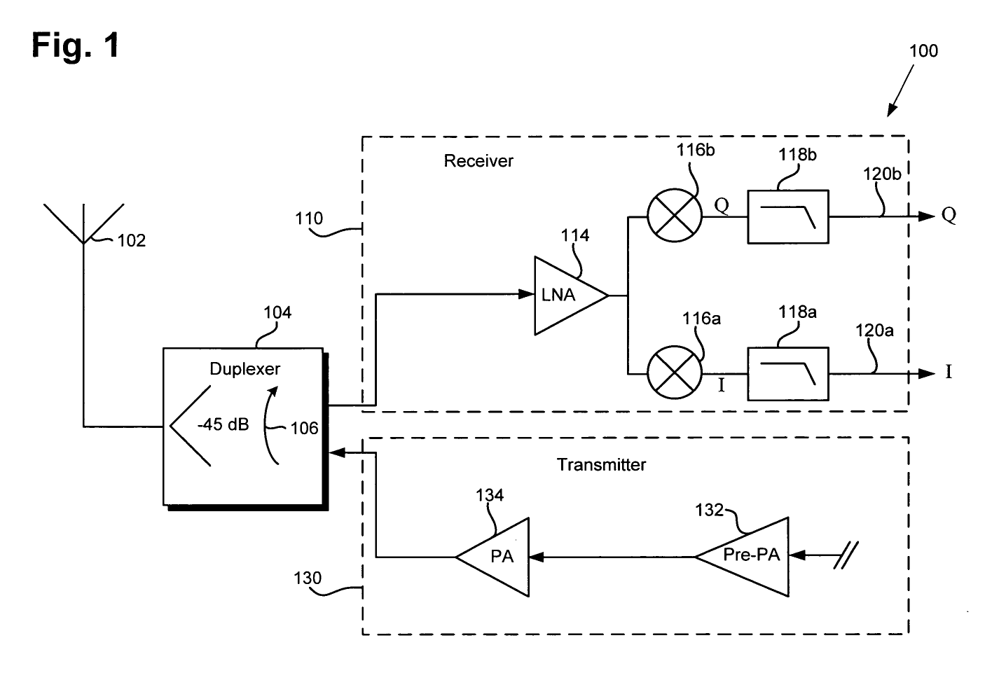

FIG. 1 is a block diagram of a conventional approach to noise suppression in, for example, a WCDMA transceiver. FIG. 1 shows transceiver 100 comprising antenna 102, duplexer 104, receiver 110 and transmitter 130. Also shown in FIG. 1, are transmitter components: transmitter pre-power amplifier (Pre-PA) 132 and transmitter power amplifier (PA) 134, as well as the presence of transmission noise leakage 106 through duplexer 104 into receiver 110. The broken lines at the input of Pre-PA 132 indicate the presence of other transmitter components (not shown), which contribute to a transmission signal delivered to duplexer 104 by transmitter PA 134.

In addition, transceiver 100 in FIG. 1 includes receiver components including low noise amplifier (LNA) 114, mixers 116a and 116b working in conjunction with, respectively, in-phase (I) and quadrature-phase (Q) signals provided by a local oscillator (not shown), low pass filters 118a and 118b, I receiver output 120a, and Q receiver output 120b. Transceiver 100 may be utilized in a cellular phone or other mobile device communicating at radio frequency (RF), for example.

In a conventional approach to implementing a transceiver, such as transceiver 100 in FIG. 1, duplexer 104 is typically utilized to isolate receiver 110 from transmitter 130, while coordinating their joint use of antenna 102 to send and receive communications signals. Taking the example of a mobile communications device operating at RF, such a device might have a range of frequencies around 1.9 GHz designated for reception, and another range of frequencies slightly lower, e.g. approximately 80 MHz lower, designated for transmission, for example. In addition, cellular phones, such as WCDMA cellular phones, and many other mobile communications devices have transceivers that operate concurrently as receivers and transmitters. As a result, during concurrent operation, noise produced by transmitter 130 at a frequency utilized by receiver 110 for reception may interfere with and degrade the quality of the received signal.

Duplexer 104, in FIG. 1, is relied upon for noise suppression in conventional implementations, and may provide as much as, for instance, −45 dB isolation between transmitter 130 and receiver 110. This finite isolation may be inadequate to entirely prevent transmission noise leakage 106 from passing into receiver 110 under certain operating conditions, however. As an illustrative example, let us consider the case of a cellular telephone at the outermost reaches of its communication range from a base station. In that situation, the transmission signal sent out from the cellular phone must be as strong as possible, to compensate for the distance from the base station, while a reception signal will be at its weakest, because of that distance.

Under those remote operating conditions, transmission noise is apt to be relatively strong, due to the need for a strong transmission signal. Duplexer 104, however, provides only a fixed and finite amount of noise suppression, so that an increase in the strength of transmission noise corresponds to an increased likelihood of transmission noise leakage 106 into receiver 110. When transmission noise leakage does occur during concurrent operation of a receiver and transmitter, and occurs in the range designated for reception frequencies, it is processed like any other reception signal. In other words, it is amplified along with a concurrently arriving desired reception signal, and consequently interferes with the desired signal. Thus, while undesirable under any circumstances, passage of leakage current 106 into receiver 110 is particularly detrimental to reception quality when it is most likely to happen, that is, during remote operation when transmission noise is strongest and a reception signal at its weakest.

A conventional approach to limiting the transmission noise leakage during remote operation involves increasing transmitter power consumption to optimize the signal to noise ratio of the transmission signal. By burning power to achieve an advantageous signal to noise ratio, the amount of transmission noise generated, and the corresponding transmission noise leakage, may be minimized for a given transmission signal strength. However, that conventional solution imposes the disadvantages associated with requiring that mobile transceivers be equipped with high power transmitters.

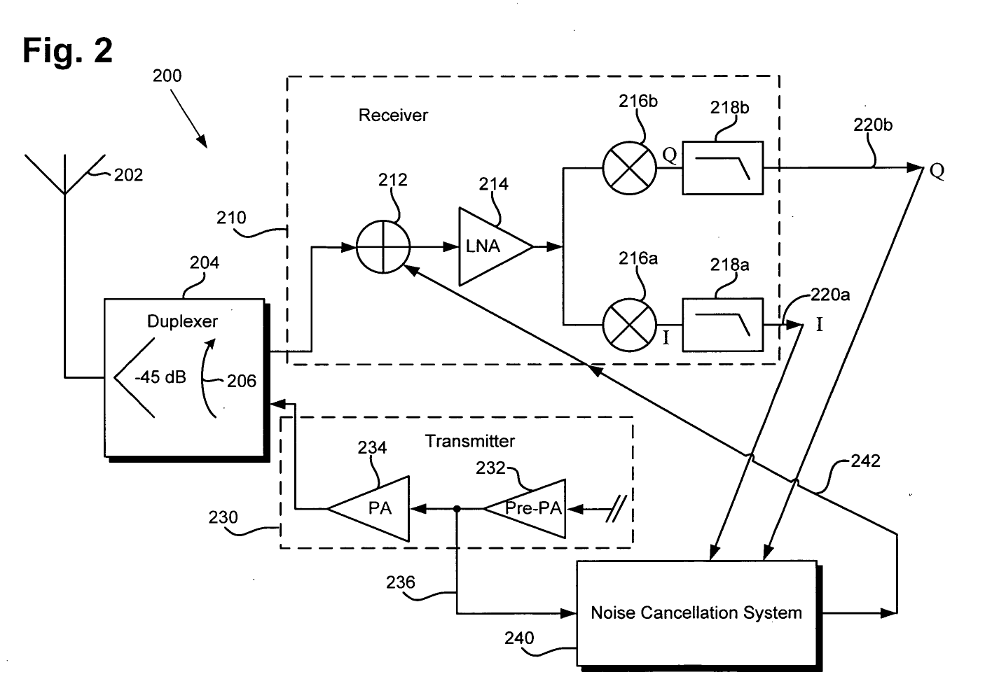

FIG. 2 is a block diagram of a transceiver providing noise cancellation, according to one embodiment of the present invention, capable of overcoming the inadequacies of the conventional approach described previously in relation to FIG. 1. FIG. 2 shows transceiver 200, comprising antenna 202, duplexer 204, receiver 210 and transmitter 230, corresponding respectively to antenna 102, duplexer 104, receiver 110 and transmitter 130, in FIG. 1. Transceiver 200 in FIG. 2 also comprises noise cancellation system 240, having no analogue in the conventional transceiver shown in FIG. 1. As shown in FIG. 2, noise cancellation system 240 receives input 236 from transmitter 230, and generates noise cancellation signal 242, which is injected into receiver 210 through summer 212. It is noted that summer 212 would typically be incorporated into LNA 214, but is represented as a separate component in the present block diagram. Moreover, as will be more fully developed in the discussion to follow, noise cancellation signal 242 has an amplitude substantially matching the amplitude of a noise signal in receiver 210, and a phase substantially opposite to the phase of that noise signal.

Also present in FIG. 2, are transmitter components transmitter Pre-PA 232 and transmitter PA 234, as well as transmission noise leakage 206, corresponding respectively to transmitter Pre-PA 132, transmitter PA 134, and transmission noise leakage 106, in FIG. 1. As in FIG. 1, the broken lines at the input of Pre-PA 232 in FIG. 2 indicate the presence of other transmitter components (not shown), which contribute to a transmission signal delivered to duplexer 204 by transmitter PA 234.

In addition, transceiver 200 in FIG. 2 comprises receiver components including LNA 214, mixers 216a and 216b, low pass filters 218a and 218b, I receiver output 220a, and Q receiver output 220b, corresponding respectively to LNA 114, mixers 116a and 116b, low pass filters 118a and 118b, I receiver output 120a, and Q receiver output 120b in FIG. 1. Transceiver 200, in FIG. 2, may be utilized in a cellular phone, wireless computer, or other mobile device, communicating at radio frequency (RF) in a range from approximately 1.8 GHz to approximately 2.1 GHz, for example.

As a specific but non-limiting example of the operation of exemplary transceiver 200, let us suppose that transceiver 200 is utilized in, for example, a WCDMA cellular telephone transmitting in a frequency range from approximately 1850 MHz to approximately 1910 MHz, and receiving in a frequency range from approximately 1930 MHz to approximately 1990 MHz. For the specific example of a cellular telephone being used here for illustration, transmitter Pre-PA 232 and the additional transmitter circuitry contributing to a transmission signal preceding transmitter Pre-PA 232 are likely to be on-chip, while transmitter PA 234 and duplexer 204 are likely to be off-chip.

As is known in the art, almost all of the transmission noise produced in a cellular phone transceiver is generated by the on-chip components, so that transmitter PA 234 can be though of as nearly noiseless. Thus, substantially all of the transmission noise produced by transmitter 230 in FIG. 2 is provided as an output of transmitter Pre-PA 232, where it is amplified by transmitter PA 234, and passed on to duplexer 204.

As mentioned previously in connection with FIG. 1, during concurrent operation of transmitter 230 and receiver 210 in FIG. 2, some of the transmission noise may be in the frequency range, i.e. approximately 1930 MHz to approximately 1990 MHz, recognized by receiver 210 as a reception signal. Under conditions of remote operation, that is, when the exemplary cellular telephone is far away from a base station, transmitter 230 may increase its transmission signal strength to compensate for the remote distance, while the strength of a desired reception signal arriving at receiver 210 is correspondingly diminished. Under these circumstances, transmitter PA 234 may provide as much as approximately 24 dB of gain to the output signal of transmitter Pre-PA 232, for example. Of course, that gain will be applied to the transmission noise generated at reception frequencies, as well as to the intended transmission signal, so that a highly amplified transmission noise signal may pass into duplexer 204, and some portion of that noise signal may penetrate the finite isolation provided by duplexer 204, and enter receiver 210 as transmission noise leakage 206.

Passage of a transmission noise signal provided as an output of transmitter Pre-PA 232 into receiver 210 involves amplification of that noise signal by transmitter PA 234, and attenuation of the amplified signal by the isolation provided at duplexer 204. The net effect on a noise signal provided by transmitter Pre-PA 232 and duplexer 204 may be represented by a transfer function presented here as Equation 1:

N_{RX}=αN_{TX}e^{jφ} (Equation 1);

where N_{RX} is the noise present in receiver 210 due to transmission noise leakage 206, N_{TX} is the noise provided as an output of transmitter Pre-PA 232, α is the net attenuation of the noise signal, and φ is the phase shift it undergoes, in radians.

The exemplary embodiment presented as transceiver 200 in FIG. 2 provides cancellation of noise signal N_{RX} in receiver 210 by injecting a noise cancellation signal having substantially the same amplitude and substantially opposite phase as noise signal N_{RX}, into receiver 210, to be combined with noise signal N_{RX} at summer 212, thereby reducing or eliminating noise signal N_{RX} prior to its amplification by LNA 214. The present embodiment accomplishes noise cancellation by extracting the values of α and φ in Equation 1 from I receiver output 220a and Q receiver output 220b, as additional inputs into noise cancellation system 240. Those inputs are used to adjust signal processing elements in noise cancellation system 240 so that input 236, that is N_{TX}, is appropriately scaled and rotated to provide noise cancellation signal 242, given by Equation 2:

N_{C}=αN_{TX}e^{j(φ-π)} (Equation 2);

where N_{C} is noise cancellation signal 242, N_{TX} is the noise provided as an output of transmitter Pre-PA 232, α is the same net attenuation appearing in Equation 1, and φ−π is a phase angle opposite to phase angle φ.

Thus, by injecting a noise cancellation signal into receiver 210, having substantially matching amplitude and substantially opposite phase to a noise signal there, the present exemplary embodiment reduces or eliminates that noise, thereby canceling a significant source of interference with a desired reception signal passing into receiver 210. As a result, reception quality may be substantially improved over that available using conventional transceiver implementations relying solely on duplexer 204 for noise suppression. Moreover, unlike conventional approaches to minimizing transmission noise, the present embodiment does not require that transceiver 200 be equipped with a high power transmitter, in order improve its signal to noise ratio when transmitting to a distant base station. This is true because noise cancellation system 240 is self-regulating in response to noise actually present in receiver 210, as a result of feedback provided through I receiver output 220a and Q receiver output 220b. Consequently, an increase in transmission noise leakage 206 automatically results in adjustment of the scaling and rotation performed by noise cancellation system 240, making it possible for a transmitter power level to be selected independently of any effect that power level might have on transmission noise leakage 206.

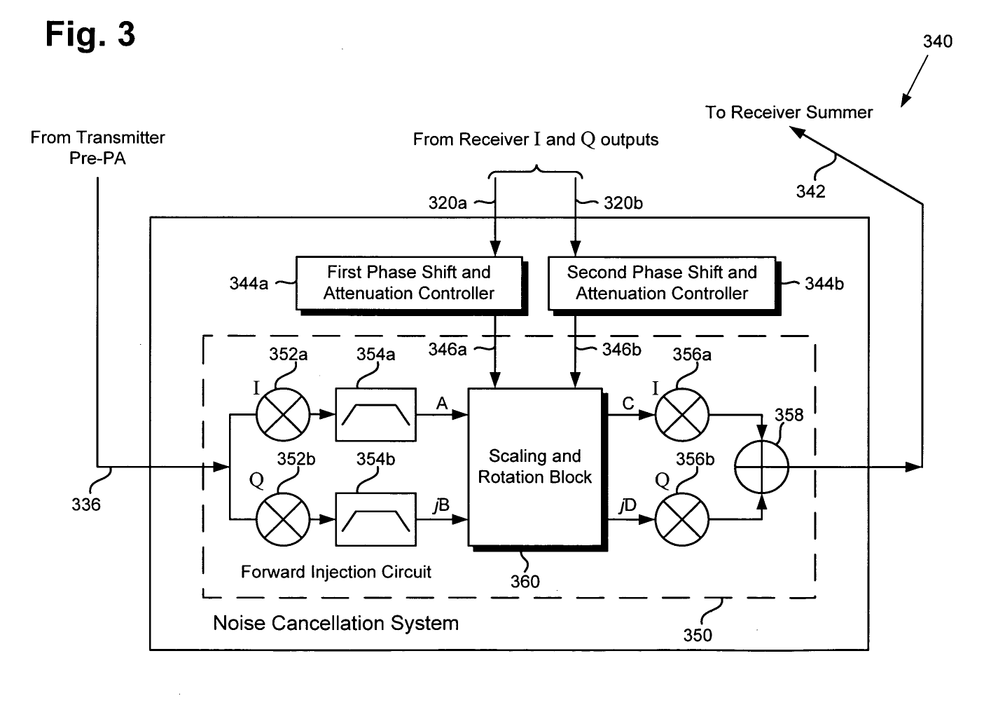

FIG. 3 shows an exemplary noise cancellation system, according to one embodiment of the present invention. Noise cancellation system 340 in FIG. 3 receiving input 336 from a transmitter Pre-PA (not shown in FIG. 3), additional inputs 320a and 320b from I and Q outputs of a receiver (also not shown in FIG. 3), and providing noise cancellation signal 342, is an exemplary representation of noise cancellation system 240 receiving input 236 from transmitter Pre-PA 232, additional inputs from I receiver output 220a and Q receiver output 220b, and providing noise cancellation signal 242, in FIG. 2.

Noise cancellation system 340 in FIG. 3 comprises forward injection circuit 350 including scaling and rotation block 360, as well as first and second phase shift and attenuation controllers 344a and 344b to, respectively, process feedback from I and Q outputs from the receiver and provide control inputs 346a and 346b to scaling and rotation block 360. Forward injection circuit 350 also includes mixers 352a and 352b to down-convert input 336 in conjunction with I and Q signals provided by a forward injection circuit local oscillator (not shown), band-pass filters 354a and 354b, mixers 356a and 356b to up-convert I and Q components of a scaled and rotated noise cancellation signal in conjunction with the same forward injection circuit local oscillator used for down-conversion, and summer 358 providing noise cancellation signal 342 as output.

Continuing with FIG. 3 and the specific example of a cellular telephone transmitting at approximately 1900 MHz, while generating transmission noise at a reception frequency of approximately 1980 MHz, we can see that input 336 to noise cancellation system 340 will include the transmission signal at approximately 1900 MHz and the transmission noise signal at approximately 1980 MHz. Input 336 enters noise cancellation system 340, passing into forward injection circuit 350. There, input 336 is down-converted by mixers 352a and 352b and a forward injection circuit local oscillator providing I and Q signals at the transmission signal frequency of the transceiver's transmitter, in this instance approximately 1900 MHz. Down-conversion at mixers 352a and 352b produces transmission signals at essentially DC level, and transmission noise at approximately 80 MHz. Those signals are then filtered by band-pass filters 354a and 354b, which allow only the 80 MHz transmission noise signal components to pass. It is noted that while separation of a transmission signal and a transmission noise signal separated by 80 MHz would be difficult to achieve at RF, requiring a high Q filter presently unavailable in an integrated implementation, the filtering is relatively easy to accomplish after down-conversion, as occurs in the present embodiment.

After down-conversion and filtering, a substantially pure I component of the transmission noise signal emerges from filter 354a as signal A, and a similarly pure Q transmission noise component emerges from filter 354b as signal jB. Signals A and jB then enter scaling and rotation block 360. There, feedback from the receiver, provided by first and second phase shift and attenuation controllers 344a and 344b as control inputs 346a and 346b, adjust the scaling and rotation of signals A and jB, to produce respective scaled and rotated signals C and jD. Scaled and rotated signals C and jD are then up-converted at mixers 356a and 356b to the original transmission noise frequency of 1980 MHz, and added together at summer 358 to produce a scaled and rotated output signal as noise cancellation signal 342. As a result of scaling and rotation performed by scaling and rotation block 360 and adjusted by control inputs 346a and 346b, noise cancellation signal 342 has an amplitude substantially matching that of a noise signal in the receiver, and a phase substantially opposite to the phase of that receiver noise signal.

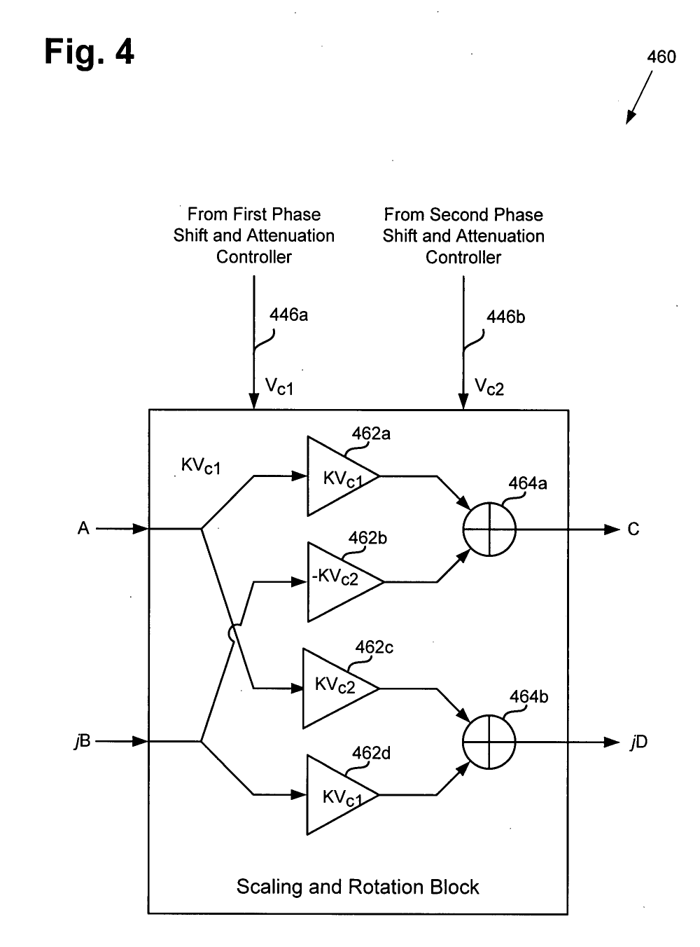

FIG. 4 illustrates a scaling and rotation block utilized in an exemplary noise cancellation system, according to one embodiment of the present invention. Scaling and rotation block 460 in FIG. 4 receiving signals A and jB, and providing output signals C and jD, is an exemplary representation corresponding to scaling and rotation block 360 receiving signals A and jB, and providing output signals C and jD, in FIG. 3. Moreover, control inputs 446a from a first phase shift and attenuation controller (not shown in FIG. 4) and 446b from a second phase shift and attenuation controller (also not shown in FIG. 4), adjusting control voltages V_{c1} and V_{c2}, respectively, correspond to control inputs 346a and 346b provided by first and second phase shift and attenuation controllers 344a and 344b, in FIG. 3. Scaling and rotation block 460 in FIG. 4 comprises first, second, third, and fourth amplifiers 462a, 462b, 462c, and 462d, respectively, as well as summers 464a and 464b.

As shown in FIG. 4, control voltages V_{c1} and V_{c2} are used to set the gains of amplifiers 462a, 462b, 462c, and 462d. Input signal A enters scaling and rotation block 460 and is split, one branch being attenuated by passage through amplifier 462a, and the other by passage through amplifier 462c. Similarly, input signal jB is split and attenuated by amplifiers 462b and 462d. The attenuated signal A output of amplifier 462a is then added to the attenuated signal jB output of amplifier 462b at summer 464a to form signal C. In a similar manner, the outputs of amplifiers 462c and 462d are added at summer 464b to form signal jD. The result of adding attenuated components of input signals A and jB to form output signals C and jD, is that output signals C and jD are effectively scaled and rotated versions of input signals A and jB.

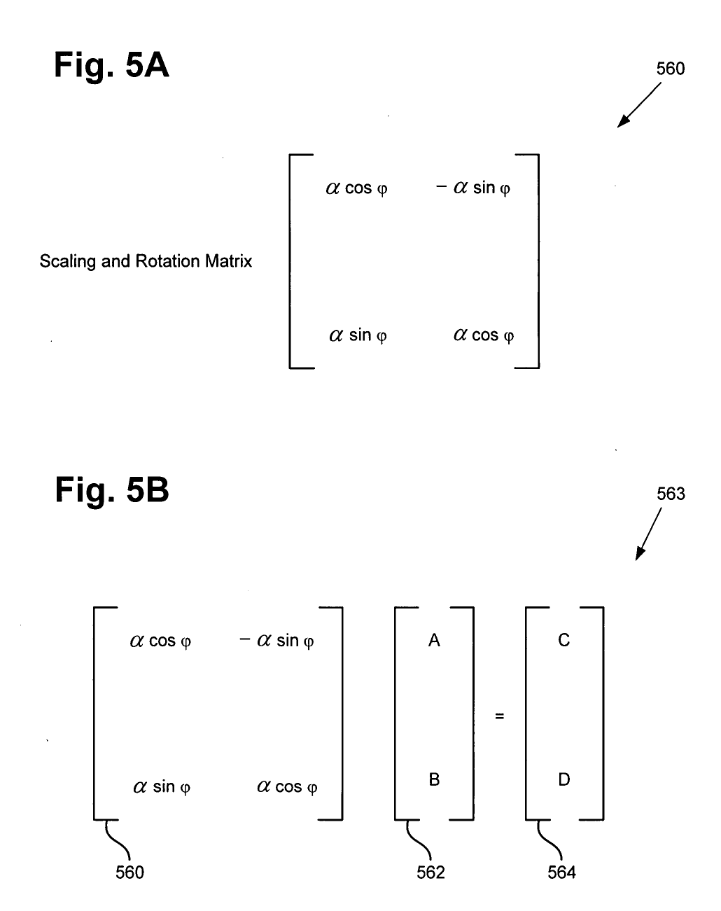

The operation of scaling and rotation block 460 may be explained by reference to an equivalent mathematical transformation. Turning now to FIGS. 5A and 5B, FIG. 5A shows a scaling and rotation matrix corresponding to the operation of the scaling and rotation block of FIG. 4. As can be seen from FIG. 5A, matrix 560 is a linear operator turning a two dimensional vector into a second two dimensional vector scaled by ax and rotated by angle φ, compared with the original vector. FIG. 5B shows an equation corresponding to the transformation of signal components A and jB, into, respectively, scaled and rotated signal components C and jD in FIG. 4. Equation 563 in s FIG. 5B shows scaling and rotation matrix 560 operating on two dimensional vector 562 (vᵢₙ) having components of magnitude A and B, to produce two dimensional vector 564 (vₒᵤₜ) having components of magnitude C and D. Operation of scaling and rotation matrix 560 thus produces vₒᵤₜ=α vᵢₙ e^{jφ}. Appropriate selection of the rotation angle φ, such that φ=(φ−π), gives Equation 3:

Vₒᵤₜ=α vᵢₙ e^{j(φ-π)} (Equation 3)

However, because vᵢₙ is the down-converted and filtered version of the noise signal received as input 336 to noise cancellation system 340 in FIG. 3, while vₒᵤₜ is noise cancellation signal 342 in that figure, prior to up-conversion, Equation 3 is equivalent to Equation 2, which provides the scaling and rotation necessary to provide a signal having an amplitude substantially matching an amplitude of the receiver noise signal given by Equation 1, and a phase substantially opposite the phase of the receiver noise signal of Equation 1. Thus, scaling and rotation block 460 in FIG. 4 performs the mathematical operation given by Equation 563 in FIG. 5B, to provide the necessary scaling and rotation of an input noise signal to produce an output noise cancellation signal.

In its various embodiments, the present invention's transceiver and system providing noise cancellation can be utilized in an electronic system in, for example, a wireless communications device, a cellular telephone, a Bluetooth enabled device, a computer, a satellite set-top box, a WCDMA RF transceiver, a personal digital assistant (PDA), or in any other kind of system, device, component or module utilized as a transceiver in modern electronics applications.

By scaling and rotating a noise signal actually generated in a transceiver to produce a noise cancellation signal adjusted to a noise signal present in the transceiver receiver, the present invention provides dynamic and responsive noise cancellation, in contrast to the fixed noise suppression techniques used in conventional implementations. As a result, the present invention preserves reception quality even during remote operation of a mobile communication device, when reception signals may be weak and transmission noise particularly strong. Thus, embodiments of the present invention's transceiver and system providing noise cancellation result in a significant improvement in reception quality at all reception distances, while advantageously allowing for transceiver implementations using low power transmitters.

From the above description of the invention it is manifest that various techniques can be used for implementing the concepts of the present invention without departing from its scope. Moreover, while the invention has been described with specific reference to certain embodiments, a person of ordinary skill in the art would recognize that changes can be made in form and detail without departing from the spirit and the scope of the invention. The described embodiments are to be considered in all respects as illustrative and not restrictive. It should also be understood that the invention is not limited to the particular embodiments described herein, but is capable of many rearrangements, modifications, and substitutions without departing from the scope of the invention.

Thus, a noise cancellation system for transceivers has been described.

1. A transceiver having a transmitter and a receiver, said transceiver comprising:
a noise cancellation system receiving input from said transmitter;
said noise cancellation system generating a noise cancellation signal injected into said receiver;
said noise cancellation signal having an amplitude substantially matching an amplitude of a noise signal in said receiver, and a phase substantially opposite to a phase of said noise signal in said receiver.

2. The transceiver of claim 1 wherein said transceiver is an RF transceiver.

3. The transceiver of claim 2 wherein said transceiver operates in a frequency range from approximately 1.8 GHz to approximately 2.1 GHz.

4. The transceiver of claim 1 wherein said noise cancellation system comprises a forward injection circuit including a scaling and rotation block to perform a scaling and rotation of said input from said transmitter.

5. The transceiver of claim 4 wherein said forward injection circuit down-converts and filters said input from said transmitter prior to said scaling and rotation.

6. The transceiver of claim 4 wherein said noise cancellation system further comprises first and second phase shift and attenuation controllers coupled to outputs of said receiver.

7. The transceiver of claim 6 wherein an output of said first and second phase shift and attenuation controllers set a first control voltage and a second control voltage of said scaling and rotation block, thereby determining said scaling and rotation.

8. The transceiver of claim 1 utilized as a part of an electronic system, said electronic system being selected from the group consisting of a wireless communications device, a cellular telephone, a Bluetooth enabled device, a computer, a satellite set-top box, a WCDMA RF transceiver, and a personal digital assistant (PDA).

9. A transceiver having a transmitter and a receiver, said transceiver comprising:
a forward injection circuit including a scaling and rotation block, coupled to an output of an amplifier of said transmitter, said forward injection circuit providing a noise cancellation signal to an input of said receiver;
first and second phase shift and attenuation controllers coupled to outputs of said receiver, said first and second phase shift and attenuation controllers providing inputs to said scaling and rotation block.

10. The transceiver of claim 9 wherein said noise cancellation signal has an amplitude substantially matching an amplitude of a noise signal in said receiver, and a phase substantially opposite to a phase of said noise signal in said receiver.

11. The transceiver of claim 9 wherein said inputs to said scaling and rotation block provided by said first and second phase shift and attenuation controllers set a first control voltage and a second control voltage, thereby determining a scaling and rotation provided by said scaling and rotation block.

12. The transceiver of claim 9 wherein said transceiver is an RF transceiver.

13. The transceiver of claim 12 wherein said transceiver operates in a frequency range from approximately 1.8 GHz to approximately 2.1 GHz.

14. The transceiver of claim 12 wherein said forward injection circuit down-converts and filters said input from said transmitter prior to a scaling and rotation provided by said scaling and rotation block.

15. The transceiver of claim 9 utilized as a part of an electronic system, said electronic system being selected from the group consisting of a wireless communications device, a cellular telephone, a Bluetooth enabled device, a computer, a satellite set-top box, a WCDMA RF transceiver, and a personal digital assistant (PDA).

16. A noise cancellation system comprising:
a forward injection circuit comprising at least two mixers providing down-converted in-phase (I) and quadrature-phase (Q) noise components of an input noise signal, and respective I component and Q component filters passing said down-converted I and Q noise components;
said forward injection circuit further comprising a scaling and rotation block to receive said down-converted I and Q noise components and provide a noise cancellation signal.

17. The noise cancellation system of claim 16, further comprising first and second phase shift and attenuation controllers providing control inputs to said scaling and rotation block.

18. The noise cancellation system of claim 16 wherein said noise cancellation is signal has an amplitude substantially matching an amplitude of a noise signal to be canceled, and a phase substantially opposite to a phase of said noise signal to be canceled.

19. The noise cancellation system of claim 16 utilized in an RF transceiver.

20. The noise cancellation system of claim 16 utilized as a part of an electronic system, said electronic system being selected from the group consisting of a wireless communications device, a cellular telephone, a Bluetooth enabled device, a computer, a satellite set-top box, a WCDMA RF transceiver, and a personal digital assistant (PDA).
